(19) United States
(12) Patent Application Publication
(10) Pub. No.: US 2012/0183785 A1
(43) Pub. Date: Jul. 19, 2012

(54) HIGH-TEMPERATURE RESISTANT CRYSTALLIZING SOLDER GLASSES

(75) Inventors: Steffen Schirrmeister, Muelheim an der Ruhr (DE); Bernd Langanke, Holzwickede (DE); Thomas Schiestel, Stuttgart (DE); Bjoern Hoting, Berlin (DE)

(73) Assignees: BORSIG PROCESS HEAT EXCHANGER GMBH, Berlin (DE); THYSSENKRUPP UHDE GMBH, Dortmund (DE)

(21) Appl. No.: 13/392,978

(22) PCT Filed: Aug. 25, 2010
(86) PCT No.: PCT/EP2010/005194

§ 371 Date: Apr. 2, 2012

(30) Foreign Application Priority Data
Aug. 31, 2009 (DE) 102009038812.5

(51) Int. Cl. B32B 15/04; B32B 18/00; B32B 17/06; C03C 3/095; C03C 3/118

(52) U.S. Cl. 428/428; 501/64; 501/59; 428/433

(57) ABSTRACT

High-temperature-resistant devitrifying solder glasses that contain 20-45 mol % BaO, 40-60 mol % SiO₂, 0-30 mol % ZnO, 0-10 mol % Al₂O₃, 0-5 mol % BaF₂, 0-2 mol % MgO, 0-2 mol % CaO, 0-2 mol % TiO₂ and 0-10 mol % B₂O₃, as well as 0.5-4 mol % M₂O₃ (M=Y, La or rare earth metals) and/or 0.5-4 mol % ZrO₂. The application, of said solder glasses are also disclosed.

The invention relates to a high-temperature-resistant devitrifying solder glass that has a specific composition according to claim 1 and can be used as a sealing solder glass.

It involves using a glass that devitrifies during the sealing operation performed at high temperatures, causing crystal phases with high coefficients of thermal expansion to precipitate.

Solder glasses and devitrifying solder glasses are now often used to produce bonds where, for example, two metals or alloys of differing composition or two ceramics of differing composition or structure or else a metal and a ceramic are joined together. One or both of the materials to be joined may also consist of a metal/ceramic composite.

Oxygen-transporting ceramic membranes are used in particular in high-temperature processes. They represent, for instance, a cost-effective alternative to cryogenic air separation for the recovery of oxygen and are used in the production of syngas by partial oxidation of hydrocarbons, such as methane, according to the following reaction:

2CH₄+O₂→2CO+4H₂ (1)

Other applications are, for example, the recovery of oxygenated air as described, for instance, in DE 102005 006 571 A1, the oxidative dehydrogenation of hydrocarbons or hydrocarbon derivatives, the oxidative coupling of methane to C₂₊ and the decomposition of water and nitrous oxide.

Ceramic membranes are often used as tubes, these often being integrated into modules. Ceramic hollow fibres with a diameter of less than 5 mm represent a special form of tube. Such modules should be chemically and thermally resistant while at the same time guaranteeing a hermetic seal. Tube or hollow-fibre membranes can be integrated into modules by embedding—or potting—them in a casting compound, also known as a potting compound or bonding material.

Ceramic materials which are the same as or similar to the ceramic membrane material itself are considered to be suitable materials for this purpose as they exhibit optimum compatibility. However, there is a problem in that such layers cannot be hermetically sinter-sealed without irreversibly changing the ceramic hollow-fibre membranes themselves. A method for creating such modules using ceramic material as a potting compound is described, for example, in EP 0941759 A1.

WO 2006089616 describes a potting that consists of at least three layers containing at least two different casting compounds. The two outer layers can be formed from ceramic material and the layer in the middle can be formed from glass. A drawback of this method of potting is that on account of its oxides, such as zirconium oxide or iron oxide, glass represents an extremely reactive component and destroys the oxidative constituents of the ceramic material.

Therefore, the design of chemically and thermally resistant modules with ceramic tube, hollow-fibre or capillary membranes requires an adaptation of the potting materials.

Normally, glasses that melt at a lower temperature have higher coefficients of thermal expansion than glasses that melt at a higher temperature. Consequently, when a solder glass is to be employed as the sealing joint for a material bond at a higher temperature (e.g. 800° C.), there are no glasses that have, for example, a melting temperature >800° C. and at the same time a coefficient of thermal expansion >10×10⁶ K⁻¹. In such cases, a mechanically and thermally stable sealing joint cannot be produced via a solder glass but it can via a devitrifying solder glass.

In order to produce a devitrifying solder glass, a glass of a suitable composition is first melted and then cooled to room temperature without it devitrifying before being pulverised with the aim of achieving typical particle sizes of between 1 and 200 μm. The glass powder is then applied to one or both of the workpieces to be joined. A number of additives, such as aqueous or non-aqueous solvents, oils or polymer solutions, can be used for this. However, it is also possible to apply ceramic films to one or both of the workpieces to be joined.

In a further step the workpieces to be joined are then heated with the solder glass to a suitable temperature. The glass particles thus sinter together and bond with the two workpieces to be joined. However, it is also possible not to put the workpieces together until a high temperature has been reached. The sintering should occur through the viscous coalescence of the glass. Once the glass particles have largely sintered together and bonded with the workpieces to be joined, devitrification should occur. The devitrification process can, however, also be induced through a temperature change, with a temperature above or below the actual joining temperature being used depending on the chemical composition of the solder glass. On completion of the joining process, the workpieces are joined tightly together.

Glass ceramic materials with widely varying compositions count as state of the art. For example, glass ceramics from the BaO—CaO—Al₂O₃—SiO₂ system are used to join high-temperature fuel cell stacks. In addition to a high temperature resistance, this material needs to meet the following demands. The joining material needs to be extremely stable; it should have an electrically isolating property and it must not react with gases, such as H₂, O₂, H₂O and CH₄. In addition, it should bond well with the metallic surface of the fuel cell stack (Schwickert T. et al. Mat.-wiss. u. Werkstofftech. 33, 363-366, 2002).

A glass ceramic that is specifically suitable for use in embedding—or potting—ceramic membranes in solid metallic forms again needs to meet special requirements. Alongside a temperature resistance of up to 900° C. and a hermetic seal, the glass ceramics used must be chemically inert to oxide ceramics that have a perovskite structure, a brownmillerite structure or an Aurivillius structure, and/or also be chemically inert to high-temperature metallic materials. This counteracts the problem of material destruction mentioned above.

Moreover, the glass ceramics must have a coefficient of thermal expansion that is equivalent or similar to that of oxide ceramics and/or a coefficient of thermal expansion that is equivalent or similar to that of high-temperature metallic materials.

Metals mostly have linear coefficients of thermal expansion of between 10×10⁻⁶ and 16×10⁻⁶ K⁻¹. If the coefficients of expansion do not match that of the solder material, stress will occur on temperature changes and this will ultimately lead to the destruction of the bond. In general, differences in the linear coefficient of thermal expansion of less than 1−2×10⁻⁶K⁻¹ can be tolerated. If the workpieces to be joined have different coefficients of thermal expansion, the expansion coefficient of the devitrified solder glass should preferably be in the middle.

The sintering and devitrification of the solder glass are not always separate or separable processes with respect to time and temperature. Rather, they usually take place simultaneously, the sintering rate increasing alongside the temperature. The same also applies to the speed of devitrification of the glass. Therefore, a time and temperature frame in which the sintering process takes place considerably faster than devitrification should be found in the case of each concrete joining problem. A devitrifying sealing solder glass must therefore have the right (high) expansion coefficient, be able to be sintered under the respective applicable conditions before devitrification occurs and also be sufficiently thermally stable, i.e. not melt, at use temperature.

Oxidic crystal phases that have a high thermal expansion and can be precipitated from oxidic glasses are primarily earth alkali silicates. One finds in the literature quantitative descriptions of the phases BaSi₂O₅ and Ba₃Si₅O₁₃ in G. Oelschlegel, Glastechnische Berichte 44 (1971), 194-201, as well as Ba₂Si₃O₈ in G. Oelschlegel, Glastechnische Berichte 47 (1974), 24-41, also with regard to their linear coefficients of thermal expansion. One also finds in the literature descriptions of glass ceramics with other earth alkali oxides (SrO, CaO) that also have coefficients of thermal expansion >10×10⁻⁶, for example in Lahl, J. Mater. Sci. 35 (2000) 3089, 3096. In addition to the desired crystal phase and high coefficients of thermal expansion, these glass ceramics also consist of other phases. These may be crystal phases of other compositions or glass phases, and in most cases they have much lower coefficients of thermal expansion. The reason for this consists in the fact that a glass of, for example, the composition 50 BaO×50 SiO₂ devitrifies much too quickly to sinter hermetically as powder. The devitrification process would, in this case, begin much too soon and prevent sintering.

The devitrification process can be slowed down by relatively small amounts of additives, such as boric oxide or aluminium oxide. This is, however, also associated with a reduction in the coefficient of thermal expansion.

It is also known that these components, if anything, aid devitrification in other glass compositions. For example, one very often finds in the literature that ZrO₂ acts as a nucleant, Maier, cfi Ber. DKG 65 (1988) 208, Zdaniewski, J. Am. Ceram. Soc. 58 (1975) 16, Zdaniewsi, J. Mater. Sci, 8 (1973) 192. In the MgO/Al₂O₃/SiO₂ system volume nucleation cannot even be induced without adding ZrO₂ Amista et al. J. Non-Cryst. Solids 192/193 (1995) 529. Here, surface devitrification is observed in the absence of ZrO₂ (or TiO₂). The volume nucleation rate is in this case increased by many orders of magnitude by adding a few % ZrO₂.

The present invention has the objective of developing a devitrifying solder glass that exhibits all of the above properties and avoids the above problems associated with current state-of-the-art glass ceramics.

This is achieved by using a high-temperature-resistant devitrifying solder glass that contains 20-45 mol % BaO, 40-60 mol % SiO₂, 0-30 mol % ZnO, 0-10 mol % Al₂O₃, 0-5 mol % BaF₂, 0-2 mol % MgO, 0-2 mol % CaO, 0-2 mol % TiO₂ and 0-10 mol % B₂O₃, as well as 0.5-4 mol % M₂O₃ (M=Y, La or rare earth metals) and/or 0.5-4 mol % ZrO₂. Other fluxing agents which are known to persons skilled in the art can also be used instead of the BaF₂.

In accordance with the invention the additives known in the art can be combined with other additives, primarily La₂O₃ and/or ZrO₂. Surprisingly, even small additions of ZrO₂, La₂O₃ or rare earths are extremely effective. However, the additives La₂O₃ or ZrO₂ also suppress devitrification without the simultaneous presence of B₂O₃ or Al₂O₃, and thus permit the use of a devitrifying solder glass.

The high-temperature-resistant devitrifying solder glasses preferably contain 35-45 mol % BaO, 40-50 mol % SiO₂, 5-8 mol % Al₂O₃, 0-2 mol % MgO, 0-2 mol % CaO, 0-2 mol % TiO₂ and 5-10 mol % B₂O₃, as well as 0.5-4 mol % M₂O₃ (M=Y, La or rare earth metals) and/or 0.5-4 mol % ZrO₂.

A further advantageous composition of the high-temperature-resistant devitrifying solder glasses is 20-30 mol % BaO, 50-60 mol % SiO₂, 10-25 mol % ZnO, 0-3 mol % Al₂O₃ and 0.5-3 mol % B₂O₃, as well as 0.5-4 mol % M₂O₃ (M=Y, La or rare earth metals) and/or 0.5-4 mol % ZrO₂.

Furthermore, a high-temperature-resistant devitrifying solder glass composed of 30-40 mol % BaO, 40-50 mol % SiO₂, 0-10 mol % ZnO, 5-8 mol % Al₂O₃ and 2-10 mol % B₂O₃, as well as 0.5-4 mol % M₂O₃ (M=Y, La or rare earth metals) and/or 0.5-4 mol % ZrO₂ is claimed.

The high-temperature-resistant devitrifying solder glass is preferably composed of 34-44 mol % BaO, 40-50 mol % SiO₂, 5-8 mol % Al₂O₃, 0-5 mol % BaF₂, 0-2 mol % MgO, 0-2 mol % CaO, 0-2 mol % TiO₂ and 5-10 mol % B₂O₃ as well as 0.5-4 mol % M₂O₃ (M=Y, La or rare earth metals) and/or 0.5-4 mol % ZrO₂.

The high-temperature-resistant devitrifying solder glass optionally contains 35-40 mol % BaO, 40-48 mol % SiO₂, 0-2 mol % MgO, 0-2 mol % CaO, 0-2mol % TiO₂ and 4-6 mol % B₂O₃, as well as 4-6 mol % Al₂O₃, 1-3 mol % M₂O₃ (M=Y, La or rare earth metals) and/or 1-3 mol % ZrO₂.

An especially favoured composition of the high-temperature-resistant devitrifying solder glass is 22-28 mol % BaO, 45-55 mol % SiO₂, 15-19 mol % ZnO, 0-2 mol % Al₂O₃, 0-2 mol % MgO, 0-2 mol% CaO, 0-2 mol % TiO₂ and 0-2 mol % B₂O₃, as well as 0.5-2 mol % M₂O₃ (M=Y, La or rare earth metals) and/or 0.5-2 mol % ZrO₂.

It is an advantage to produce the devitrifying solder glasses from melted, pulverised glass with a particle size of 1 and 200 μm, preferably these are produced from melted, pulverised glass with a particle size of 10 and 150 μm and especially favoured is melted, pulverised glass with a particle size of 30 and 125 μm—the rule being the finer the particle size, the quicker the devitrification.

The high-temperature-resistant devitrifying solder glass is advantageously used as a hermetic sealing solder glass to join high-temperature metallic materials and ceramics or else ceramic/metal composite materials. Preferably, a metal and a ceramic are joined together during this process. Especially favoured are a high-temperature nickel-based metallic material and an oxide ceramic, the oxide ceramic advantageously having a perovskite-like structure or a brownmillerite structure or else an Aurivillius structure and the ceramic preferably having a stabilised cubic or tetragonal zirconium oxide structure.

The present invention is to be described below using the following examples of embodiments.

### Embodiment Example 1

A ceramic hollow fibre suitable for separating air in the pressure gradient (mixed electron/oxygen ion conductors) is to be joined to a high-temperature nickel/iron-based alloy. Both of the materials to be joined have linear coefficients of thermal expansion of 14−15×10⁻⁶K⁻¹ in the temperature range of 25 to 850° C.

A 2 mm thick hole is drilled through the metal. In the same place the metal is drilled approximately 4 mm deep using a drill with a diameter of 8 mm in order to produce a conical cavity, at the cone point of which the 2 mm drill hole is located. Now, a ceramic hollow fibre with a diameter of 1.8 mm is inserted into this drill hole. 0.3 g of a glass powder composed of 15ZnO.25BaO.1B₂O₃.1ZrO₂.1La₂O₃.57SiO₂ is put into the conical cavity.
For this, a grain size fraction of 50-80 μm obtained through screening is used.
Then the assembly of metal, hollow fibre and glass is put in an oven and heated to a temperature of 900° C. The heating rate is 5K/min. The end temperature is maintained for 1 h and the oven is then cooled.
A hermetic sealing joint is obtained. The bond can be used at temperatures of up to 900° C.

### Embodiment Example 2

A ceramic hollow fibre and a high-temperature alloy with properties as described in embodiment example 1 are to be joined together.
A cylindrical hole with a depth of 4 mm and a diameter of 10 mm is drilled in the metal. Then, in total seven holes, each with a diameter of 1.5 mm, are drilled in the bottom of this drill hole. Hollow-fibre membranes with a diameter of 1.3 mm are inserted through these holes.
A glass composed of 36.25.BaO.7.5 Al₂O₃.5B₂O₃.2ZrO₂.2La₂O₃.3BaF₂.44.25SiO₂ with a grain size fraction of 30-125 μm is used to produce the sealing joint. From this, a pourable slurry is produced using a 2% solution of polyvinyl alcohol in water and this is filled into the cylindrical hole.
After drying, the assembly is brought to a temperature of 950° C., the rate of heating being 1K/min up to 600° C. and 5K/min at a higher temperature.

### Embodiment Example 3

A ceramic hollow fibre and a high-temperature alloy with properties as described in embodiment example 1 are to be joined together.
A hollow-fibre bundle is inserted into a polymer mould (Ø=25mm).
A ceramic, non-aqueous slurry based on ethanol, polyvinyl butyral and hydroxypropyl cellulose is produced from a glass composed of 41.75.BaO7.5Al₂O₃5B₂O₃1ZrO₂1La₂O₃.42.25SiO₂ using a grain size fraction of 30-50 μm, which was produced through screening.
The slurry is poured into the polymer mould. It is then dried and the solid form is taken out of the mould and sintered in the oven at 920° C. After sintering, the solid form has a diameter of 22 mm.
The solid sintered form is then put on a metal plate with a hole (Ø=16 mm) so that the hollow fibres, the inner edge of the metal plate and the glassy crystalline solid form (Ø=22 mm) overlap by approximately 3 mm.
In a second temperature treatment step this assembly is then heated to 980° C. and left at this temperature for 1 h.

### Embodiment Example 4

A flat ceramic membrane (thickness 1 mm) produced by means of film technology is to be joined to a high-temperature alloy. Both materials have linear coefficients of thermal expansion of 14−15×10⁻⁶K⁻¹ in the temperature range of 25 to 850° C.
For this, a pourable slurry based on ethanol/propanol with the addition of hydroxypropyl cellulose, polyvinyl alcohol, octyl phthalate, tensides and polyethylene glycol is produced from a glass composed of 19ZnO.25BaO.1B₂O₃.2ZrO₂.2La₂O₃.51SiO₂.
This is used to produce a ceramic film using the doctor blade process. Contours are cut out of this film using a CO₂ laser. These films are then put on the metal plate and the flat ceramic membranes are subsequently applied.

This assembly is sintered at 950° C. and kept at this temperature for 1 h. The rate of heating amounted to 1K/min up to a temperature of 650° C. and 5K/min thereafter.

### Embodiment Example 5

A high-temperature alloy (linear coefficient of thermal expansion: 11.5×10⁻⁶ K⁻¹) is to be joined to a flat membrane made of stabilised tetragonal zirconium oxide ceramic (thickness 200 μm, linear coefficient of thermal expansion: 10×10⁻⁶K⁻¹) produced by means of film technology.
For this, a paste based on ethanol/propanol with the addition of hydroxypropyl cellulose, polyvinyl alcohol and octyl phthalate is produced from a glass composed of 35BaO.3B₂O₃.2ZrO₂.2La₂O₃.7Al₂O₃.51SiO₂. This paste contains 50 vol % glass and is used to produce a sealing joint between the zirconium oxide ceramic and the high-temperature alloy. This assembly is sintered at 950° C., kept at this temperature for 1 h, then brought to a temperature of 880° C. and kept at this temperature for a further 5 h. The rate of heating in each case amounted to 2K/min.

1. A glass composition suitable as a high-temperature solder glass for forming a glass ceramic, comprising:
20-30 mol % BaO,
50-60 mol % SiO₂,
10-25 mol % ZnO,
0-3 mol % Al₂O₃ and
0.5-3 mol % B₂O₃ as well as
0.5-4 mol % M₂O₃ (M=Y, La or rare earth metals) and/or
0.5-4 mol % ZrO₂.

2. A glass composition suitable as a high-temperature solder glass for forming a glass ceramic, comprising:
30-40 mol % BaO,
40-50 mol % SiO₂,
0-10 mol % ZnO,
5-8 mol % Al₂O₃ and
2-10 mol % B₂O₃ as well as
0.5-4 mol % M₂O₃ (M=Y, La or rare earth metals) and/or
0.5-4 mol % ZrO₂.

3. A glass composition suitable as a high-temperature solder glass for forming a glass ceramic, comprising:
34-44 mol % BaO,
40-50 mol % SiO₂,
5-8 mol % Al₂O₃,
1-5 mol % BaF₂,
0-2 mol % MgO,
0-2 mol % CaO,
0-2 mol % TiO₂ and
5-10 mol % B₂O₃ as well as
0.5-4 mol % M₂O₃ (M=Y, La or rare earth metals) and/or
0.5-4 mol % ZrO₂.

4. A glass composition suitable as a high-temperature solder glass for forming a glass ceramic, comprising:
35-40 mol % BaO,
40-48 mol % SiO₂,
4-6 mol % Al₂O₃,
0-2 mol % MgO,
0-2 mol % CaO,
0-2 mol % TiO₂ and
4-6 mol % B₂O₃ as well as
1-3 mol % M₂O₃ (M=Y, La or rare earth metals) and/or
1-3 mol % ZrO₂.

5. A glass composition suitable as a high-temperature solder glass for forming a glass ceramic, comprising:
22-28 mol % BaO,
45-55 mol % SiO₂,
15-19 mol % ZnO,
0-2 mol % Al₂O₃,
0-2 mol % MgO,
0-2 mol % CaO,
0-2 mol % TiO₂ and
0-2 mol % B₂O₃ as well as
0.5-2 mol % M₂O₃ (M=Y, La or rare earth metals) and/or
0.5-2 mol % ZrO₂.

6. A bond comprising a high-temperature metallic material and a ceramic, hermetically joined with a glass ceramic using a glass composition according to claim 1, said composition devitrifying during the sealing operation performed at high temperatures.

7. The bond according to claim 6, wherein a metal and a ceramic are joined together.

8. The bond according to claim 7, wherein a high-temperature nickel-based metallic material and an oxide ceramic are joined together.

9. The bond according to claim 8, wherein the oxide ceramic has a perovskite-like structure or a brownmillerite structure or an Aurivillius structure.

10. The bond according to claim 8, wherein the ceramic has a stabilised cubic or tetragonal zirconium oxide structure.

11. A bond comprising at least two ceramic/metal composite materials, hermetically joined with a glass ceramic using a glass composition according to claim 1, said composition devitrifying during the sealing operation performed at high temperatures.

12. The bond according to claim 11, wherein a metal and a ceramic are joined together.

13. The bond according to claim 12, wherein a high-temperature nickel-based metallic material and an oxide ceramic are joined together.

14. The bond according to claim 13, wherein the oxide ceramic has a perovskite-like structure or a brownmillerite structure or an Aurivillius structure.

15. The bond according to claim 13, wherein the ceramic has a stabilised cubic or tetragonal zirconium oxide structure.
